(19) United States
(12) Patent Application Publication
(10) Pub. No.: US 2011/0101239 A1
(43) Pub. Date: May 5, 2011

(54) REMOTE SENSING SYSTEM

(76) Inventors: Iain Woodhouse, Linlithgow (GB); Caroline Nichol, Edinburgh (GB); Genevieve Patenaude, Edinburgh (GB); Timothy John Malthus, Edinburgh (GB)

(21) Appl. No.: 12/991,324

(22) PCT Filed: May 8, 2009
(86) PCT No.: PCT/GB09/50490

§ 371 Date: Jan. 20, 2011

(30) Foreign Application Priority Data
May 8, 2008 (GB) 0808340.4

(51) Int. Cl. G01J 1/58; G01N 21/84; G01J 3/42; G01J 3/00

(52) U.S. Cl. 250/458.1; 436/57; 356/445; 356/51

(57) ABSTRACT

An airborne the multi-spectral lidar instrument emits and/or detects radiation from target vegetation to assess the condition of the foliage. Time of flight analysis at multiple wavelengths permits three dimensional measurements to discriminate material at different heights, from ground to top of canopy. Radiation at 531 nm (emission and detection, vertically resolved) is used to measure de-epoxidation of the xanthophyll pigments (used for PRI), and also for stimulation of fluorescence. Radiation at 550 and/or 570 or 571 nm (emission and detection, vertically resolved) serves as a reference waveband unaffected by the de-epoxidation (used for PRI). Radiation at 690 and 740 nm (Detection only, no height resolution) or other lines for chlorophyll fluorescence, optionally using Fraunhofer/Oxygen wavelength windows and/or time gating to improve SNR. Wavelengths of 860 and 1200 nm, or similar (emission and detection, vertically resolved) are applied to measurement of water absorption and estimation of NDWI. Results are combined with known available radiation to estimate primary productivity.

The invention relates to environmental remote sensing, particularly sensing of vegetation properties from air- or space-borne platforms.

The system is intended principally for use as a remote sensing instrument with the measurements made from above a vegetation canopy (on a tower, balloon, aircraft, satellite or any other high platform). It has long been recognised that remote sensing techniques could be very valuable in the monitoring of the health of ecosystems. A conventional approach to this is to use sensors responsive to a pair of different wavelengths, and use ratios of intensity between the wavelengths to distinguish green foliage (containing chlorophyll) from dead and inorganic matter. A paper surveying various developments in this field is Grace, J, Nichol, C. J., Disney, M, Lewis, P & Quaife, T (2007) “Can we measure terrestrial photosynthetic rate from space directly, using reflectance and fluorescence”, Global Change Biology 13 : 1-14. That paper includes references to prior studies which provide the scientific background and support for the techniques to be described. The detail of those references is not required for an understanding of the present invention.

Another remote sensing technique is light detection and ranging (lidar), which can provide very precise maps of height, by measuring time of flight of pulses of laser light transmitted from a flying platform and reflected back by the ground or vegetation. Lidar is useful for example to distinguish features of a forest canopy and ‘understoreys’ from the forest floor.

Instruments are known that that combine an active lidar instrument for structure and a passive multispectral imaging sensor for spectral reflectance information. However the known instruments have various certain limitations:
they suffer shadowing if passive sensor requires solar illumination (and are therefore less likely to detect surface or understorey sensitivity).
they require two different sensors working in combination that need to be co-registered. This is often problematic and suffer from spatial resolution differences

NASA Biospheric Lidar, described at http://techtransfer.qsfc.nasa.gov/ft-tech-multi-wave-lidar.html measures two wavelengths and is designed to measure chlorophyll while revealing structure. It makes no mention/use of polarisation. Unfortunately, measurement of chlorophyll alone is a poor indicator of health in the vegetation, as a plant may remain green while suffering a range of conditions indicating stress and inefficient feeding.

The inventors aim to provide more comprehensive measurement of vegetation biophysical properties as a function of height above the ground from towers, aircraft and satellite. Specifically, leaf area, leaf angle, the chlorophyll and xanthophylls concentrations and water absorption. Each provides information on physiology, photosynthesis and water stress.

The invention provides a method for the remote analysis of vegetation, the method comprising:
providing a remote sensing platform;
generating at said platform modulated emissions of laser radiation each having a different wavelength;
directing said emissions from said platform toward a target;
detecting radiation reflected by the target at each of said wavelengths;
measuring for each wavelength the reflected intensity as it varies with time of flight, thereby to provide for each wavelength a measured profile of intensity over a range of distances from the platform; and
combining the intensities of reflected radiation in said profiles measured at first and second wavelengths to obtain a profile of at least one derived parameter of said target over said range of distances.

Said modulated emissions may comprise simple pulse trains, chirps or continuous coded waveforms, whereby the strengths of reflections of the different emissions can be recognised and timed in the received signals.

The laser radiation may be generated by a separate laser for each wavelength, or by a tuneable laser switched to different wavelengths sequentially.

In a preferred embodiment, the detector for each wavelength is sensitive to a band of wavelengths less than 10 nm wide, preferably less than 2 nm. Reducing the bandwidth of detection improves the signal to noise ratio (SNR).

In the preferred embodiments, there are at least three, typically four wavelengths directed and detected, a profile for a first derived parameter being derived from combination of the profiles measured for first and second wavelengths and a profile for a second derived parameter being derived from the profiles measured third and fourth wavelengths. (In principle one wavelength may be common to both pairs, so that the system only needs three. The preferred embodiments use at least four wavelengths.)

In one such embodiment, the plurality of wavelengths include a pair that are both in the visible region of the electromagnetic spectrum, one of them selected to be affected by de-epoxidation of xanthophyll pigments while the other remains unaffected by the de-epoxidation reaction, and wherein a profile is obtained by combining the measured profiles of said pair of wavelengths. The wavelength selected to be affected by de-epoxidation may be substantially 531 nm. A selective detector with a selection band including 531 nm and having a width (FWHM) of 8 nm or less, preferably 3-6 nm, is suitable. The reference wavelength may be in the range 540-590 nm, for example around 550 nm or around 570 nm. These reference wavelengths are effectively located on the shoulder of the 531 nm response. 550 nm is selected for this purpose in some prior references. Other sources prefer a reference wavelength around 570 nm, and 571 nm in particular seems attractive in practice.

In such an embodiment, the plurality of wavelengths may include a pair of wavelengths both in the infrared region of the electromagnetic spectrum, one of them selected to be particularly absorbed by water while the other is relatively unaffected, and a parameter derived from said pair is indicative of water stress in foliage at each distance. The reference of wavelength may be around 860 nm (say 840-880 nm), while the water-sensitive wavelength is around 1200 nm (say 1180-1280 nm), for example, or around 1660 nm (1620-1690 nm, say).

The method may further include detection of radiation received from the target at least one further wavelength not among those directed at the target from the platform, said wavelength being one at which chlorophyll fluorescence is observable. This fluorescence may be caused by excitation by one of the laser wavelengths directed at the target from the platform, or by incident sunlight or a separate source. The detection is preferably made with a selectivity better than 2 nm, preferably better than 0.5 nm, the wavelength being coincident with a trough in the spectrum of solar radiation typical at the earth's surface. Such fine resolution is referred to generally as hyperspectral detection. The trough may one caused by a Fraunhofer line in the solar radiation (for example, the one at 656.3 nm) or one caused by atmospheric absorption, as for example absorption by oxygen at 760 nm. More than one further wavelength may be detected and measurements combined to improve SNR accuracy. Time gating may be applied to discriminate between actively stimulated fluorescence and passive (solar-induced) fluorescence signals.

In a preferred embodiment the detection discriminates polarised and non-polarised components of the reflected radiation. Either or both can be measured. The non-polarised component in particular represents composition deeper in the target surface.

The method may be performed from an airborne platform or spacecraft.

By use of these techniques, which can be adapted to yield better estimates of known indices or novel indices usable in future, more accurate assessment of vegetation condition can be made, and estimates of carbon take-up important for monitoring impact on climate change. In particular, values can be calculate and integrated over three dimensions, instead of being lumped or extrapolated from incomplete two-dimensional data. A preferred embodiment of the invention combines the values calculated in order to calculate gross primary productivity (GPP).

An apparatus is also provided, adapted for performance of the method. The apparatus may employ tuneable lasers for emission of desired wavelengths. The apparatus may employ photon-counting detectors to maximise sensitivity while maintaining eye-safe emission powers

The above and other features and aspects of the invention will be understood more fully from a consideration of the specific description which follows.

### BRIEF DESCRIPTION OF THE DRAWINGS

Embodiments of the invention will now be described, by way of example only, by reference to the accompanying drawings, in which:

FIG. 1 shows the principles of light direction and rangefinding (LIDAR) systems in an airborne survey application;

FIG. 2 illustrates the formation of distance profiles in (a) conventional LIDAR and (b) a novel multispectral LIDAR instrument;

FIG. 3 is a schematic block diagram of the novel multi-spectral LIDAR instrument;

FIG. 4 illustrates the typical reflectance spectrum of vegetation across the visible and infrared bands; and

FIG. 5 illustrates portions of the reflectance spectrum defined for use in known systems.

### DETAILED DESCRIPTION OF THE EMBODIMENTS

### Background

### Lidar System

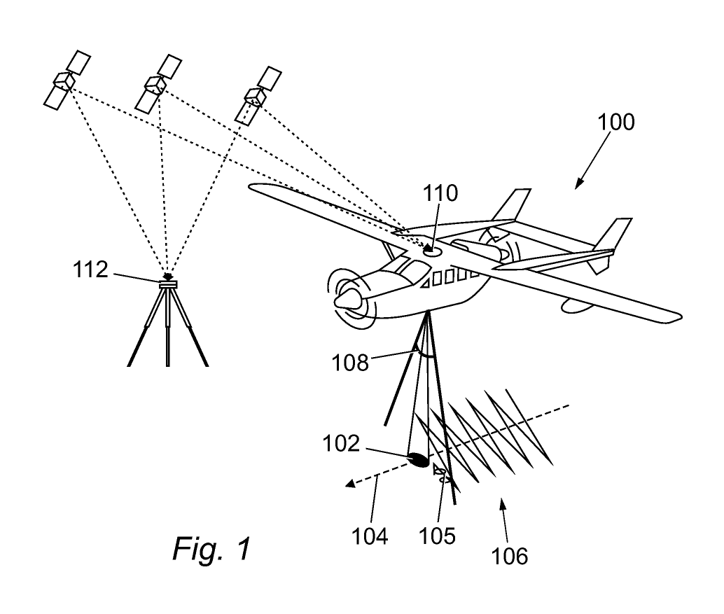

The technology of lidar for mapping ground topography from an aircraft or other elevated platform is well established. A typical set-up is shown in FIG. 1. A light aircraft 100 provides the elevated platform, for example 1200 m above the ground. A laser and optical system mounted beneath the aircraft emits a narrow beam of light (light here includes IR and UV radiation) in pulses, to project spots 102 of light onto the ground or other surface below. The light reflected from each spot is picked up through the optical system, and its time of flight is analysed to determine the height of the surface below. A vertical accuracy of 15 cm or so can be readily achieved. The plane 100 flies steadily along a track 104, while the laser beam is scanned back and forth along a series of scanning lines 105 to scan a swath 106 several hundred metres wide. For example, if the scan angle 108 is 30 degrees or so, a swath 650 m wide can be scanned from a platform altitude of 1200 m.

Each spot of light may be typically 30 cm in diameter. Using the example figures above and a pulse rate of 33 kHz, the flight speed and scanning rate can be adjusted to sample the surface every 1.5 m along a scan line, and to separate the scan lines 1.5 m apart, so that a 2-D array of evenly spaced samples is obtained.

By flying the plane in parallel tracks 104, a complete scan of an area can be performed. A GPS receiver 110 is provided on board both to guide the pilot, and to provide position data for recording as part of the lidar data set. A GPS ground station 112 can be included so that the GPS position data in the recorded data set can be corrected to eliminate systematic noise and achieve higher accuracy.

This is a known technique and need not be described further. The aircraft's GPS and inertial navigation system (INS) comprising a six-axis inertial measurement unit (IMU) and has a positional accuracy of 2 cm and 0.1 degrees for heading. The lidar instrument is integrated with this GPS/INS system to use the same data.

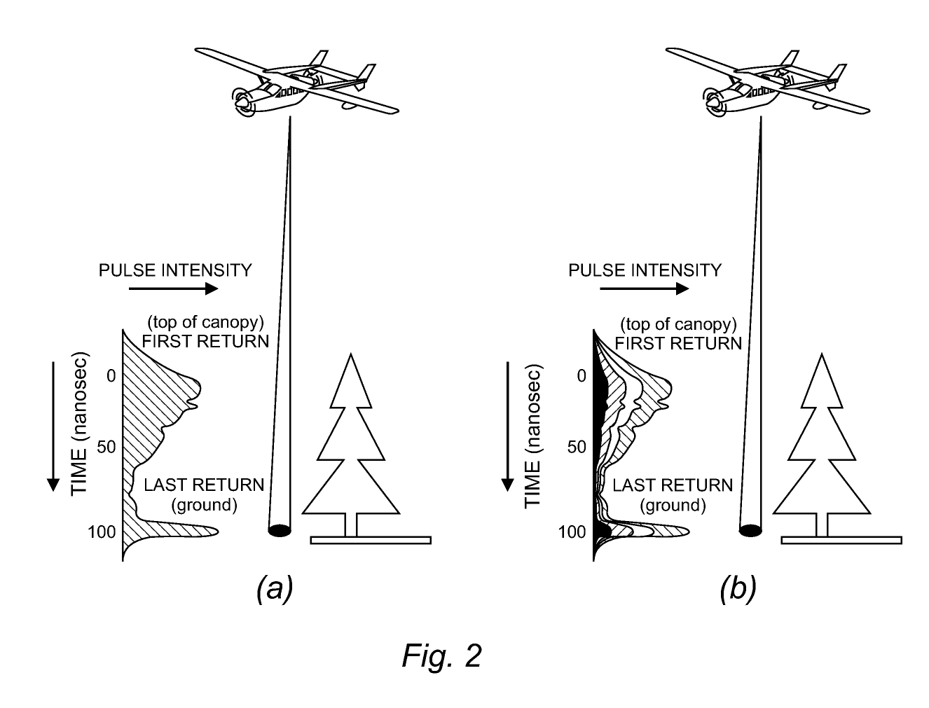

FIG. 2 (a) shows the interaction of one laser pulse with ground and vegetation in the conventional lidar altimetry system. In operation, a pulse of laser light is directed towards the surface, it is scattered/reflected at the ground surface and this signal is measured as it returns to the instrument. It is possible to measure both the intensity of the returned signal and the time delay between transmission of the pulse and its return. Since the speed of light is well-defined for a given atmosphere, the distance can be calculated from the instrument to the scattering target. When a vegetation canopy is located above the ground, the light may be scattered from different elements of the canopy and from the ground beneath. By measuring the change in the intensity of the signal as a function of time, it is possible to infer the vertical structure of the vegetation. A graph of pulse intensity against time (vertical axis) is juxtaposed with the subject in FIG. 2(a) to illustrate the correlation between this intensity/time trace and the vertical distribution of reflective surfaces (ground and vegetation).

### Multispectral Reflection Lidar System

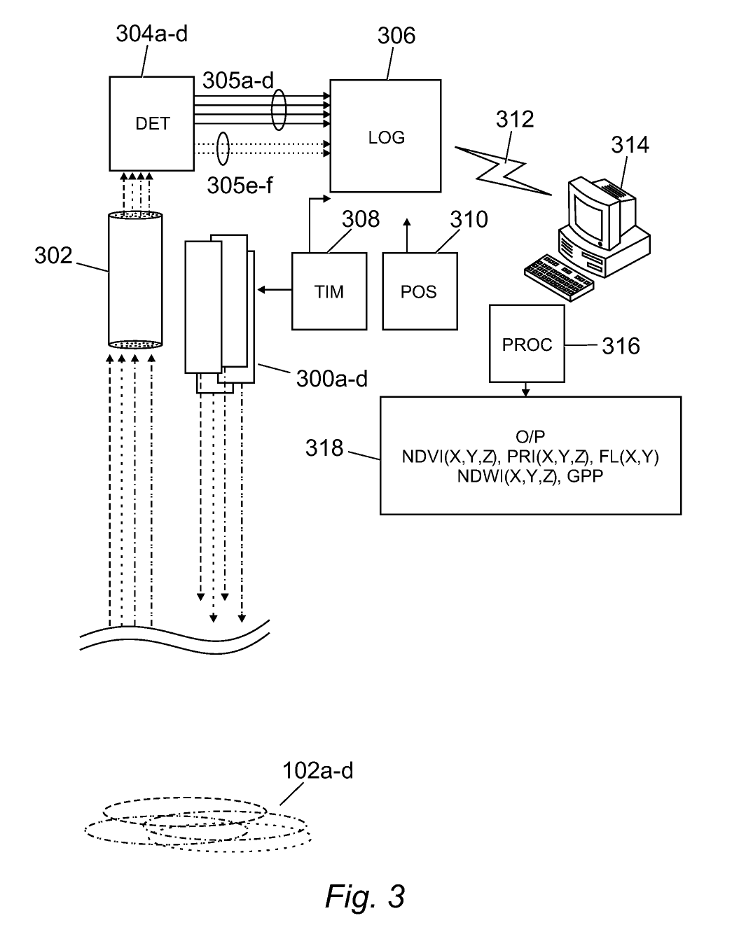

FIG. 3 is a block schematic diagram of a novel multispectral selective reflection Lidar system which generates light pulses of at least four distinct wavelengths a, b, c, d and senses returns at these transmitted wavelengths separately. The system is intended principally for use as a remote sensing instrument with the measurements made from above a vegetation canopy (on a tower, balloon, aircraft, satellite or any other high platform). The wavelengths are chosen to coincide with key points in the reflection spectra of terrestrial vegetation (details below). The airborne data acquisition apparatus thus comprises four laser sources 300a-d, each with its own characteristic wavelength, all aligned to project their light spots 102a-d on the same ground/vegetation target. A telescope 302 receives these and passes them to a set of narrowband detectors 304a-d.

Each detector 304a-d includes components sensitive specifically to one of the four distinct wavelengths, preferably with a selectivity better than 2 nm. The four time-versus-intensity traces 305a-d are recorded in a data recorder 306. Recorder 306 receives timing data from a synchronising unit 308 which also controls the emission of pulses, and receives position data from the GPS module 310.

As in known Lidar systems, the lasers sources would in practice be directed through the same optical system as the detector, using beam splitters and optical layouts well within the capability of the skilled person familiar with Lidar design. Also for practical implementation the pulses at different wavelengths can be emitted at staggered timings rather than simultaneously, to simplify the recording of data.

Knowing the timing and duration of the emitted pulses, coupled with baseline (background) measurements, the reflected lidar signals can be separated from the background radiation at the same wavelengths. Alternative implementations are of course possible, for example to use one or more tuneable lasers in place of two or more separate lasers. Simple pulse trains can be replaced by more complex chirp or continuous code modulation schemes, if desired. These may be to improve SNR and/or increase the resolution on the ground. Techniques of this sort known from single-wavelength lidar systems can be applied in a straightforward manner to the multiple wavelengths of the present system.

Additional narrowband detectors 304e-f may be provided to measure radiation at wavelengths not emitted by sources 300a-d. (These may represent reflection of solar radiation, or fluorescence, as discussed further below.) Corresponding data samples 305e-f are recorded in log 306 along with the data 305a-d.

A data link 312 transfers the logged data set to a computer system 314 which implements processing 316 to generate an output data set 318 far more detailed than in the known Lidar system of FIGS. 1 & 2(a). The data set includes various arrays of data organised for the sake of illustration on X and Y axes, with resolution also in the vertical Z direction. The co-ordinate system is of course somewhat arbitrary—in its raw form, X may be an index across one scan 105, Y can be scan number along the track 104. At some point in the analysis, these co-ordinates will typically be translated to some metre or kilometre grid, or to latitude and longitude positions. The vertical Z can be absolute above sea level, or referenced to the ground at each location. The data sets may include a separate array recording the ground height at each X, Y location. Such details of the implementation are of course important in practice but do not alter the principles of the invention.

Where the responses at different wavelengths are to be combined to obtain one parameter (such as NDVI, PRI or NDWI, discussed below), these combinations can be made before recording, if preferred. In practice, where storage space is not a major constraint, it will be preferred that the raw wavelength samples be recorded and combined values calculated later, to maintain a record of the source data for investigation of anomalies and audit purposes, and to allow experimentation with different modes of analysis. Similarly, where transformation of co-ordinates is required to map data from “sample number, scan number” to latitude and longitude or the like, it is a matter of design choice whether this is done on the raw wavelength samples, prior to obtaining the desired vegetation index values, or afterwards.

Many practical issues not material to the invention as such will of course be addressed in a real implementation. This will include for example calibration to compensate delays between the laser pulse trigger signal and emission of the pulse itself. This delay can be different for different wavelengths or power settings, for example in the case of an optical parametric oscillator-based tuneable laser. It may be compensated, or the actual pulse output may be measured instead as a timing reference. Time delays such as this can be equated to height errors in the resulting profile and compensated downstream if preferred. The pulse length will result in ‘smoothing’ of vertical resolution, which again can be tolerated or compensated by de-convolution; or a better laser can be employed. A pulse width of 4.75 ns, for example, translates to a height smoothing of 1.4 metres or so.

Other practical issues surrounding airborne laser instrumentation concern eye safety, which implies minimum pulse power and maximum detection sensitivity. Photon counting detectors may therefore be particularly useful. An example photon-counting Lidar instrument is described by Harding et al in “The Swath Imaging Multi-polarization Photon-counting Lidar (SIMPL): A Spaceflight Prototype” (2008 IEEE International Geoscience & Remote Sensing Symposium, Jul. 6-11, 2008, Boston, Mass., U.S.A. not published at the priority date of the present application).

FIG. 2(b) illustrates the response of the multispectral instrument in the same format as the conventional lidar illustrated in FIG. 2(a). Whereas the conventional instrument provides only a single graphs of reflection intensity versus time (vertical distance), the multi-wavelength instrument produces a number of traces, each representing the intensity of a different wavelength by the ground surface and vegetation material. By comparing these different intensities sampled at each height from the ground to the top of the canopy, the novel instrument can be used to determine the presence of particular pigments within living plants as a function of height above the ground.

In a preferred embodiment, the relative proportions of the scattered signals across the four wavelengths reflect the relative abundance of at least two of chlorophyll, xanthophylls and water, preferably all three. In combination, this gives direct information on the physiology and photosynthesis rates, plant health and carbon dioxide uptake as a function of height above the ground.

Previous workers have combined altitude-measurement lidar with passive spectral instrumentation to monitor plant health from the sky, but with limited success. Passive sensors are those which detect reflected and scattered solar illumination, in contrast to a lidar system which detects reflections of radiation emitted by the instrument. The novel multispectral lidar sensor enables a number of problems to be overcome compared with those previous attempts to make these measurements. Firstly, it makes the spectral and range measurements from the same location (monostatic) and with its own light source (the lidar emitters). Thus there are no issues to do with solar illumination direction (shadows) in the spectral information and therefore improved information on the vertical distribution of the spectral response. In so doing, it also reduces the uncertainty in establishing which return pulses correspond to canopy, understorey or ground surface. In particular, for survey applications where ground measurements are required, the multispectral information will allow the returns from the non-photosynthesising ground surface to be unambiguously distinguished from understorey.

The following sections detail the science of the measurements and the particular choice of wavelengths. Additional options will be described as well.

### Wavelength Selection

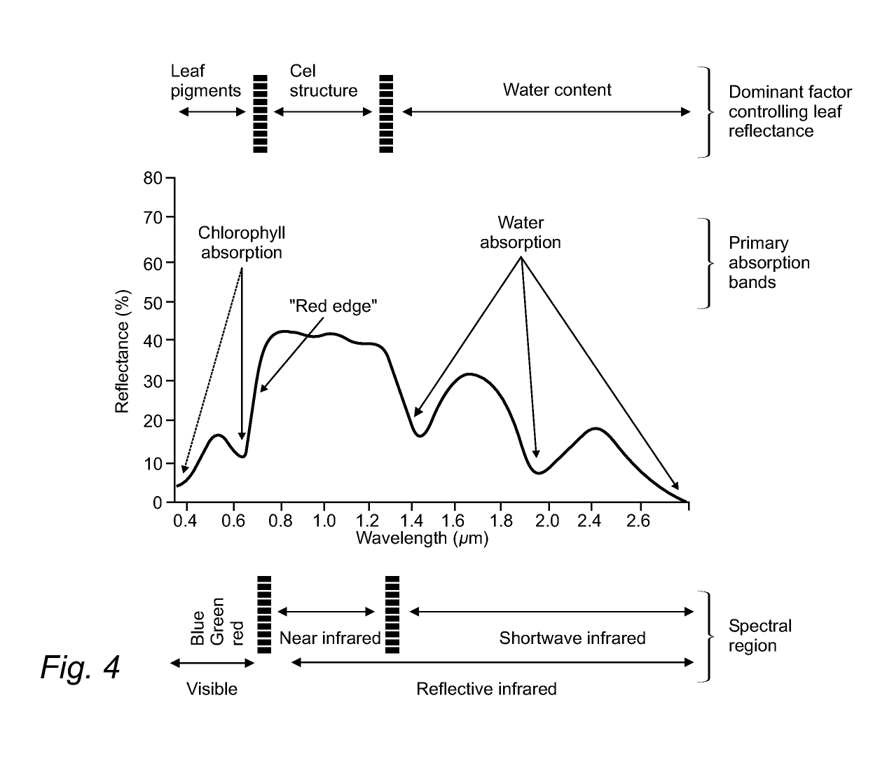

FIG. 4 shows the spectral reflectance of vegetation across the visible and infrared bands. All healthy vegetation shows a similar trend. The current description is concerned with reflectance over the entire range of 400 nm to 3 microns (3 μm), but takes optimum advantage of the narrow bandwidth sensing available with the lasers used in lidar systems. The active region of the waveband with respect to photosynthesis is usually assumed to be 400-700 nm, with the rest of the region being related to cell structure and water content.

By combining the responses of vegetation at different wavelengths, various useful parameters and indices can be defined and measured/calculated, some of which have been defined already in the prior art. Some of these have been measured by remote sensing in the past, but with difficulty, others have been measured only by other means under laboratory conditions or on the ground. Examples will now be described.

### NDVI (Normalized Difference Vegetation Index)

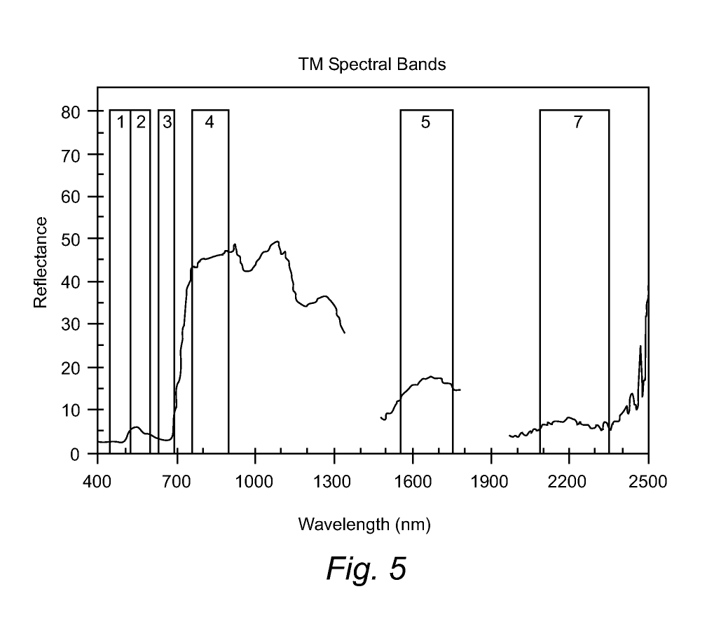

As background, multi-spectral satellite remote sensing of the Earth's surface began in 1972 with the launch of ERTS-1, later renamed LANDSAT 1. It was possible to detect variations in the leafiness of the land cover from its reflectance measured in broad spectral bands. FIG. 5 shows these bands numbered 1, 2, 3, 4, 5 and 7 Rouse et al. (1973) proposed a simple index, known as the normalized difference vegetation index (NDVI), based on the reflectances R_{red} and Rₙᵢᵣ observed respectively in the red (630-690 nm) and near infrared (760-900 nm) parts of the solar spectrum (Bands 3 and 4 respectively). The red wavelengths 660 nm and/or 690 nm and infrared wavelength 780 nm might be used, for the sake of example only. The definition of NDVI is:

NDVI=(Rₙᵢᵣ−R_{red})/(Rₙᵢᵣ+R_{red}).

This index NDVI is essentially a measure of ‘greenness’: it has been used to estimate the leaf area per unit of land area (leaf area index (LAI)) but it bears a linear relationship with the fraction of solar radiation that green leaves in the canopy absorb (fAPAR). Multiplying the absorbed radiation NDVI by a constant factor known as the Radiation Use Efficiency (RUE or ε) provides a means to estimate the rate of photosynthesis (or biomass accumulation) per land area.

NDVI and other such normalized ratios are known to be affected by topography, variations in viewing and illumination angles, atmospheric influences, and variations in soil brightness but NDVI has been for many years the Earth observation workhorse to quantify vegetation amount and radiation absorbed. For example, some authors have shown how NDVI is increasing in the northern hemisphere, and they have deduced that photosynthesis is therefore increasing, probably as a result of climatic warming. Unfortunately, NDVI measures only the ‘greenness’ of the land cover and not the process of photosynthesis itself. Consequently, when ε has been determined from careful ground measurements of the rate of increase in biomass and absorbed radiation it is found to be rather variable. In a review of 13 cases published between 1977 and 1985, Cannell et al. (1987) found that ε varied from 0.8 to 2.1 g biomass for every MJ (megajoule) of solar radiation absorbed. This variation is not surprising as green leaves, in the short-term (hours or days), remain green but reduce photosynthesis when they are stressed. Only at longer time scales, when prolonged stress causes premature senescence or abscission would stress eventually show as a change in NDVI.

Undoubtedly, NDVI is especially useful for picking up seasonal and interannual variations in the overall ‘condition of the canopy’, especially in relation to drought, and relating these variations to the capacity of the canopy to photosynthesize. At the same time, the magnitude of ε is fundamentally determined by the quantum efficiency of photosynthesis, which is known to be reduced by stress factors, which may include extreme temperatures, direct sunlight, or shortage of water and nutrients. Superimposed on this there may be changes in stomatal conductance associated with drought, which will certainly reduce the rate of photosynthesis. Thus, ε is inherently variable.

### Hyperspectral Sensing

While measurements such as NDVI can be made on a relatively broadband basis, other types of measurement and analysis are possible only with narrowband or ‘hyperspectral’ sensing. We shall regard bandwidths of 10 nm or less as hyperspectral for the purposes of the present description and claims, and note that selectivity under 2 nm is preferred in practice, ideally 0.5 nm or even 0.1 nm.

### Photochemical Reflectance Index (PRI)

Frequently light exceeds the amount that can be used for photosynthesis. Even for healthy foliage, this happens on most days in bright sunshine. Additionally, stress factors can depress the rate of photosynthesis, for example when bright light and low temperatures are combined, or when drought occurs. At these times, energy is diverted from chlorophyll to the xanthophylls cycle, as part of a process known as non-photochemical quenching (NPQ). This is a protective mechanism, preventing the reaction centres from becoming over-excited and therefore damaged.

It has been noted that dynamic changes in the xanthophyll cycle are accompanied by a reflectance change in a narrow region of the visible spectrum centred at 531 nm. This photo-protective mechanism varies over the diurnal time course and also in response to various stress factors acting over longer time scales. Gamon et al, 1992, define a photochemical reflectance index (PRI) to detect unequivocally these changes in reflectance. Their index is based on measurement in two narrow wavebands, one centred on 531 nm, which is affected by the de-epoxidation of the xanthophyll pigments, and a reference waveband centred on 570 nm, which remains unaffected by the de-epoxidation reaction. The photochemical reflectance index (PRI) is expressed as

PRI=(R₅₃₁−R₅₇₀)/(R₅₃₁+R₅₇₀)

where R_{λ} refers to the narrow-band (<2 nm) reflectance centred on the wavelength λ in nm. We may note in passing that, although the form of the PRI and NDVI expressions are the same, the wavelengths required for NDVI as defined from LANDSAT™ bands are quite different and therefore the two indices are independent of each other. We may also note that NDVI is conventionally a broadband index and, therefore, easy to measure using existing systems. PRI, on the other hand, requires hyperspectral sensors. Passive hyperspectral sensors have recently become available aboard satellites. MODIS ocean wavebands centred on 531 and 570 nm are 10 nm broad, which is much broader than the ideal for PRI but may nevertheless be useful.

As reported in the Grace et al paper, PRI has been found to be strongly correlated with ε at the leaf scale, small canopy scale and recently at the ecosystem scale. It has also been shown that PRI provides an optical measure of Radiation Use Efficiency ε across species and nutrient levels. Visualization of PRI over the surface of leaves provides a clear indication of how spatial variations in photosynthetic efficiency may vary over time. Now, there is considerable interest in using PRI at the large spatial scale (say from around 10 m² to 10 km²) calculated from spectral reflectance measured on remote sensing platforms to assess ε and model global ecosystem dynamics. The novel system described above makes such observation a practical possibility.

A benefit of using a multispectral lidar to measure PRI, rather than a passive hyperspectral instrument, is that canopy structure is an important factor in determining the overall reflectance since it encapsulates the transition from individual scattering elements with known hemispherical reflectance and transmittance properties to a far more complex arrangement where multiple interactions between the scatterers and the lower boundary (soil and understorey vegetation) combine to form the resulting (measured) signal at the top of the canopy. The scatterers themselves (leaves, stems, branches) vary in developmental stage and orientation, both of which have the potential to influence the PRI. Thus, when variations in PRI are seen using passive sensors, it is not immediately clear how far the apparent differences may be a consequence of variations in illumination and viewing angle, and canopy structure. The novel system allows vertical structure of the canopy to determine simultaneously with the PRI, and in particular allows separation of canopy from understorey and soil. Indeed, we can determine the PRI as a function of height above the ground surface, since multiple wavelength measurements are determined at each range (height) bin.

Referring again to FIG. 3 then, if two of the wavelengths emitted and detected are selected to be 531 nm and, say, 550 nm as a reference, the output data set 318 can include a traces of PRI against height at each sample location. This data might be in an array PRI(X,Y,Z) where, for the sake of illustration, latitude, longitude and altitude are expressed directly or through a convenient transformation in the dimensions X, Y and Z used to index the array. As mentioned above, the literature offers various options for the reference wavelength, such as 550, 570 or 571 nm.

### Fluorescence and Fraunhofer Lines

During photosynthesis, part of the energy captured by chlorophyll is dissipated as fluorescence (re-emission of light energy at a longer wavelength than the excitation energy) within the waveband 650-800 nm, with peaks at 690 and 740 nm. Chlorophyll fluorescence, combined with NPQ (non-photochemical quenching) is interpreted as an expression of the balance between light harvesting (absorption), and light utilization in the photosynthetic process. The 690 nm fluorescence signal from leaves and crops is therefore widely used by physiologists and agronomists as a field-based or laboratory-based diagnostic tool for detection of stress. In principle, this fluorescence is very closely related to the efficiency of light utilization as it represents ‘wasted’ energy.

It is usual to make inferences from the changes in fluorescence over several minutes following illumination. However, in the more natural state of continuous illumination by sunlight, photosynthetic organisms fluoresce continuously, thus adding a weak signal to the spectral reflectance. This is called solar-induced steady-state fluorescence, Fs, or ‘passive fluorescence’. The novel instrument in a preferred embodiment includes an additional hyperspectral sensor 304e sensitive to this fluorescence signal, so that additional information can be gained corresponding to the locations scanned by the lidar system.

The passive fluorescence signal in practice is less than 3% of the reflected energy (and <2% in most cases), but in principle it can be separated from the reflectance signal. In particular, by using a narrow bandwidth receiver, our instrument design should be able to detect and measure plant fluorescence by examination of the faint radiance in the well known dark lines (Fraunhofer lines) observed within the solar spectrum, caused by absorption in the sun's outer atmosphere. There are several hundred of these, produced by absorption of energy by the cooler gases near the solar surface. Almost all of the lines are very narrow (0.04-0.4 nm), but only one of them (656.3 nm) is within the red region of the spectrum where most of the chlorophyll fluorescence occurs (650-800 nm). There are other dark lines in the solar radiation received at the earth's surface, produced by the absorption of energy by oxygen in the terrestrial atmosphere. Using an instrument mounted above the canopy, others have demonstrated a good relationship between ‘passive’ fluorescence measured at 760 nm, and the fluorescence parameters measured on leaves using traditional physiological methods (pulse-modulated chlorophyll fluorescence with a PAM2000 portable fluorimeter). Any of these wavelengths can be selected for the fluorescence measurement. Indeed, the SNR of the fluorescence measurement can be boosted by measuring in several of the narrow spectral windows.

Additionally to the sensing of passive fluorescence signals, there is the option to use active sources to excite fluorescence for measurement. This may be by the provision of additional laser sources, or using one or more of the lidar wavelengths for this additional purpose. By using the laser pulses at the shorter wavelength at 531 nm we will be able to optimize the chlorophyll fluorescence emittance at the red and far-red peaks (around 680-700 and 735-745 nm). The detected fluorescence signals may in that case be time-resolved (vertically resolved), provided that the pulse width and fluorescence stimulation-emission delay do not conspire to smear all height resolution. In practice, the delay between stimulation and emission of the fluorescent radiation is in the nanosecond range, which may allow meaningful height discrimination. Delays can be calibrated out of the signals by reference to the reflectance wavelength profiles. Even if time-of-flight resolution is not desired, time-gated detection should be applied in the circuitry 304-308, to register the fluorescence wavelength only in the instants following emission of a stimulating pulse.

Shorter wavelength excitation (say, 480-500 nm) could be used to trigger a blue/green fluorescence as well as the desired (red) chlorophyll fluorescence. This blue/green fluorescence is stronger than the red fluorescence, but is not well correlated with changes in leaf level physiology across all vegetation types. Therefore we prefer to concentrate on the red fluorescence and the green/blue fluorescence is either not stimulated, or is filtered by wavelength and/or gated out by timing circuitry.

Note that the Fraunhofer lines and other notches in the incident solar spectrum can in principle be exploited to improve the SNR of reflectance measurements, not only the fluorescent emissions.

The excitation radiation at 531 nm may stimulate fluorescence at wavelengths detected for the NDVI measurements. The contribution should be small (<2%), but in principle would introduce artefacts into the NVDI profile. To exclude the artificial contribution from the NDVI measurement, it is proposed to use gated detection in the NDVI measurement bands, synchronised with the excitation pulses, so as to ignore radiation received at the periods when fluorescence has been stimulated. (This is effectively the inverse of the gating function applied to enhance SNR in the measured stimulated fluorescence.)

### Canopy Water Content

There is an established index for assessing canopy water content with the Normalized Difference Water Index (NDWI), defined as:

NDWI=[(R₈₆₀−R₁₂₄₀)/(R₈₆₀+R₁₂₄₀)]

where subscripts again refer to reflectance at wavelengths in nm.

By emitting pulses of radiation at 860 nm and 1240 nm and measuring vertical responses at both wavelengths for each sample point, the novel system is able to assess the vertical distribution of water stress within a canopy.

Referring again to FIG. 3 then, if two of the wavelengths emitted and detected are selected to be 860 nm and 1240 nm, then with appropriate processing the output data set 318 can include a trace of NDWI against height at each sample location. This data might be in an array NDWI(X,Y,Z) where, for the sake of illustration, latitude, longitude and altitude are expressed directly or through a convenient transformation in the dimensions X, Y and Z used to index the array.

The exact wavelengths are not critical, and others may be selected according to the quality of experimental results found, and of course practical issues with the availability and performance of the relevant emitters and detectors.

Referring again to FIG. 4, the water content of vegetation can alternatively be determined by measuring reflectance at the two strong absorption lines around 900 nm and 1100 nm. In the shortwave infrared there area also water absorption bands around 1400 nm, 1660 nm and 1900 nm. These can be used instead of or in addition to the wavelengths mentioned above.

### Polarisation

It will be understood that the radiation emitted and received back by the instrument will include both polarised and non-polarised components. Optional implementations of the apparatus include polarising filters in the detectors 304, either for certain wavelengths or for all wavelengths. Use of only the non-polarised component of the returned scattered pulse can improve the measurements by increasing the relative proportion of the signal originating from within the leaves rather than the surface.

In a preferred embodiment, the apparatus will measure both polarised and non-polarised signals, to allow comparison and maximise utilisation of the available radiation. The emitted radiation may of course be polarised, but the return signal may still be non-polarised, by scattering within the target medium.

### CONCLUSION

The following list identifies the novel wavelengths proposed for a preferred implementation of the multi-spectral lidar instrument:
531 nm (emission and detection, vertically resolved): Measures de-epoxidation of the xanthophyll pigments (used for PRI), and also for stimulation of fluorescence.
550 and/or 570 or 571 nm (emission and detection, vertically resolved): Reference waveband unaffected by the de-epoxidation (used for PRI)
690 and 740 nm (Detection only, no height resolution) or other lines for chlorophyll fluorescence, optionally using Fraunhofer/Oxygen wavelength windows and/or time gating to improve SNR.
860 and 1200 nm, or similar (emission and detection, vertically resolved): Measurement of water absorption and estimation of NDWI.

The above specific wavelengths are of course examples. Other wavelengths offering similar sensitivity can be used instead or in parallel and wavelengths within a 5 or 10 nm band either side will generally suffice. Specific alternatives and margins are given in various cases above.

The novel apparatus and analysis may be applied to carbon sequestration studies, forest management, forest health, tree health, agricultural crop monitoring, precision agriculture, and to improve the measurements of ground topography from survey lidar.

A particular application is to the measurement or estimation of ‘gross primary productivity’ (GPP), defined as the uptake of carbon (biomass accumulation) by the vegetation. The PRI provides a measure of light use efficiency ε as explained above. It is well established that NDVI explains the fraction of absorbed radiation (fPAR/APAR) within the canopy. With incident PAR (photosynthetically active radiation) being a readily available dataset, GPP becomes available as the product of the measured parameters.

GPP=APAR·ε

or

GPP=fPAR·PAR·ε

The ability to estimate these factors and multiply them in three dimensions greatly enhances the reliability of the valuable GPP result.

Many optional features and variations of the novel system have been described already. These and other modifications can be made without departing from the spirit and scope of the invention defined in the introduction above.

1. A method for the remote analysis of vegetation, the method comprising:
providing a remote sensing platform;
generating at said platform modulated emissions of laser radiation each having a different wavelength;
directing said emissions from said platform toward a target;
detecting radiation reflected by the target at each of said wavelengths;
measuring for each wavelength the reflected intensity as it varies with time of flight, thereby to provide for each wavelength a measured profile of intensity over a range of distances from the platform; and
combining the intensities of reflected radiation in said profiles measured at first and second wavelengths to obtain a profile of at least one derived parameter of said target over said range of distances.

2. A method as claimed in claim 1, wherein said modulated emissions comprise simple pulse trains, whereby the strengths of reflections of the different emissions can be recognised and timed in the received signals.

3. A method as claimed in claim 1, wherein said modulated emissions comprise chirps or continuous coded waveforms, whereby the strengths of reflections of the different emissions can be recognised and timed in the received signals.

4. A method as claimed in claim 1, wherein the laser radiation is generated by a tuneable laser switched to different wavelengths sequentially.

5. A method as claimed in claim 1, wherein the detector for each wavelength is sensitive to a band of wavelengths less than 10 nm wide, preferably less than 5 nm or less than 2 nm.

6. A method as claimed in claim 1, wherein there are at least four wavelengths directed and detected, a profile for a first derived parameter being derived from combination of the profiles measured for first and second wavelengths and a profile for a second derived parameter being derived from the profiles measured third and fourth wavelengths.

7. A method as claimed in claim 6, wherein the plurality of wavelengths include a pair that are both in the visible region of the electromagnetic spectrum, one of them selected to be affected by de-epoxidation of xanthophyll pigments while the other remains unaffected by the de-epoxidation reaction, and wherein a profile is obtained by combining the measured profiles of said pair of wavelengths.

8. A method as claimed in claim 7, wherein the wavelength selected to be affected by de-epoxidation is substantially 531 nm, while the reference wavelength is in the range 540-590 nm.

9. A method as claimed in claim 6, wherein the plurality of wavelengths includes a pair of wavelengths both in the infrared region of the electromagnetic spectrum, one of them selected to be particularly absorbed by water while the other is relatively unaffected.

10. A method as claimed in claim 9, wherein the reference of wavelength is around 860 nm (say 840-880 nm), while the water-sensitive wavelength is around 1200 nm (say 1180-1280 nm), or around 1660 nm (1620-1690 nm, say).

11. A method as claimed in claim 1, further including detection of radiation received from the target at least one further wavelength not among those directed at the target from the platform, said wavelength being one at which chlorophyll fluorescence is observable.

12. A method as claimed in claim 11, wherein said fluorescence is caused by excitation by one of the laser wavelengths directed at the target from the platform.

13. A method as claimed in claim 11, wherein the detection is made with a selectivity better than 2 nm, preferably better than 0.5 nm, the wavelength being coincident with a trough in the spectrum of solar radiation typical at the earth's surface.

14. A method as claimed in claim 1, wherein the detection discriminates polarised and non-polarised components of the reflected radiation.

15. An apparatus for remote analysis of vegetation, the apparatus including components for emitting, receiving and recording radiation at a plurality of wavelengths, and being adapted for deployment on a remote sensing platform so as to perform the method of claim 1.

16. An apparatus as claimed in claim 15, adapted for implementing the method of claim 6.
